(19) United States
(12) Patent Application Publication
(10) Pub. No.: US 2012/0077407 A1
(43) Pub. Date: Mar. 29, 2012

(54) SPORTS BOARD INCLUDING A LAMINATED BOTTOM LAYER

(75) Inventor: Aifu Shen, Ningbo (CN)

(73) Assignee: KEEPER SPORTS PRODUCTS, LLC, Oceanside, CA (US)

(21) Appl. No.: 13/090,033

(22) Filed: Apr. 19, 2011

(30) Foreign Application Priority Data
Sep. 25, 2010 (CN) 201010294678.7

(51) Int. Cl. B32B 5/24; B32B 7/08; B32B 3/26

(52) U.S. Cl. 442/370; 428/304.4; 156/93

(57) ABSTRACT

A sports board includes a foam core, a cloth cover layer, and a slick outer layer that is laminated to at least the bottom surface of the cover layer. A method of making a sports board includes adding graphics to at least one of the upper and lower portions of a cover layer, then laminating a slick outer layer to at least a bottom surface of the lower portion of the cover layer. The edges of the of upper and lower portions of the cover layer are then sewed together, while leaving an opening at one end so that the resultant cover “bag” may be filled with granular foam material. After the cover bag is filled with the foam material, the opening in the cover layer is sewed closed to form a sports board pre-structure. The sports board pre-structure is then placed in a molding apparatus to undergo a molding process.

### PRIORITY CLAIM

This application claims priority to Chinese Patent Application No. 201010294678.7, filed Sep. 25, 2010.

### TECHNICAL FIELD

The invention relates to a sports board to be used for snow-sledding, water-boarding, body-boarding, surfing, and so on, and a manufacturing method thereof.

### BACKGROUND

Sports boards commonly include a top surface formed from a cloth material including graphics, and a bottom surface formed from nylon or a similar material. The core of the board typically includes expanded polystyrene (“EPS”) beads or a similar material. The top and bottom surfaces are sewed together around the core, after which the board is placed in a molding apparatus into which steam is introduced, causing the EPS beads to expand and form to the shape of the mold. The resultant sports board includes a cloth upper surface and a nylon lower surface.

### SUMMARY

A sports board includes a foam core, a cloth cover layer, and a slick outer layer. The foam core is wrapped in the cover layer, and the slick outer layer is laminated to at least the bottom surface of the cover layer.

A method of making a sports board includes adding graphics to at least one of the upper and lower portions of a cover layer, then laminating a slick outer layer to at least a bottom surface of the lower portion of the cover layer. The edges of the of upper and lower portions of the cover layer are then sewed together, while leaving an opening at one end so that the resultant cover “bag” may be filled with granular foam material. After the cover bag is filled with the foam material, the opening in the cover layer is sewed closed to form a sports board pre-structure. The sports board pre-structure is then placed in a molding apparatus to undergo a molding process. After molding, the completed sports board is removed from the molding apparatus.

Other features and advantages will appear hereinafter. The features described above can be used separately or together, or in various combinations of one or more of them.

### BRIEF DESCRIPTION OF THE DRAWINGS

In the drawings, wherein the same reference number indicates the same element throughout the views:

FIG. 1 is a bottom plan view of a sports board, according to one embodiment.

FIG. 2 is a side elevation view of the sports board shown in FIG. 1.

FIG. 3 is a sectional view taken along line A-A of FIG. 1.

FIG. 4 is an enlarged view of Section I of FIG. 2.

FIG. 5 is an enlarged drawing of Section II of FIG. 3.

FIG. 6 is a top plan view of the sports board shown in FIG. 1.

FIG. 7 is a bottom plan view of the cover layer of the sports board before it is filled with a foam core.

FIG. 8 is a top plan view of the cover layer shown in FIG. 7.

### DETAILED DESCRIPTION OF THE DRAWINGS

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

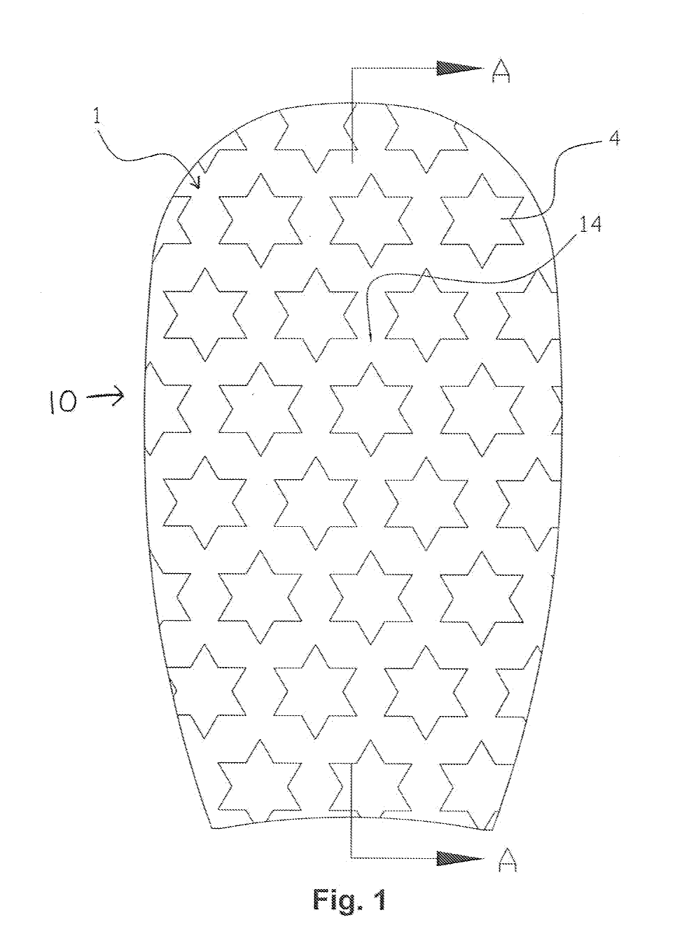

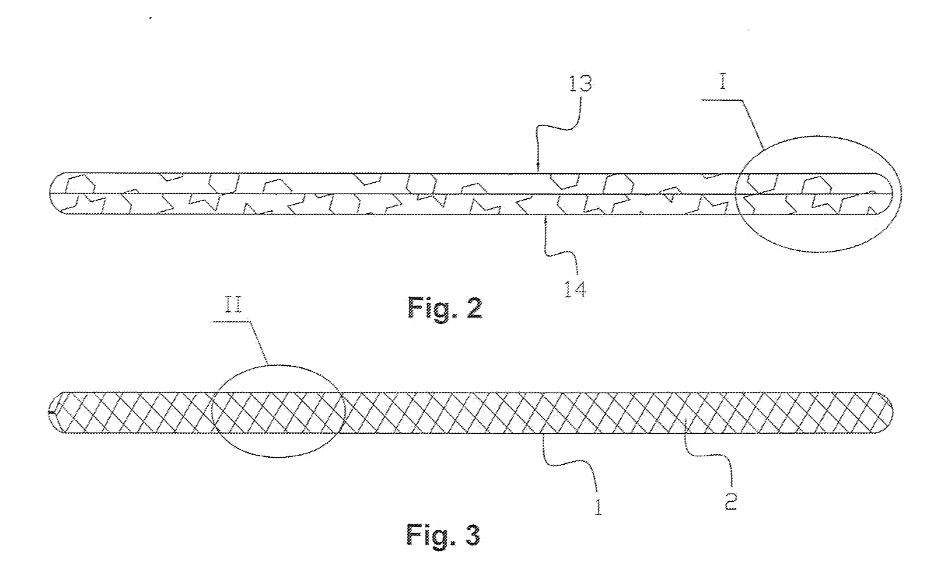

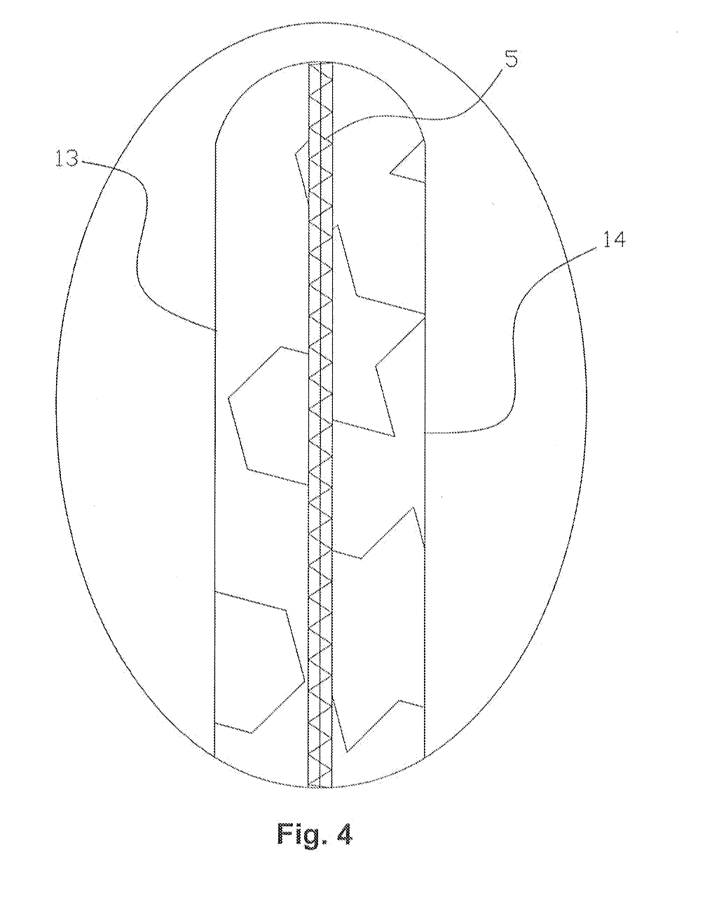

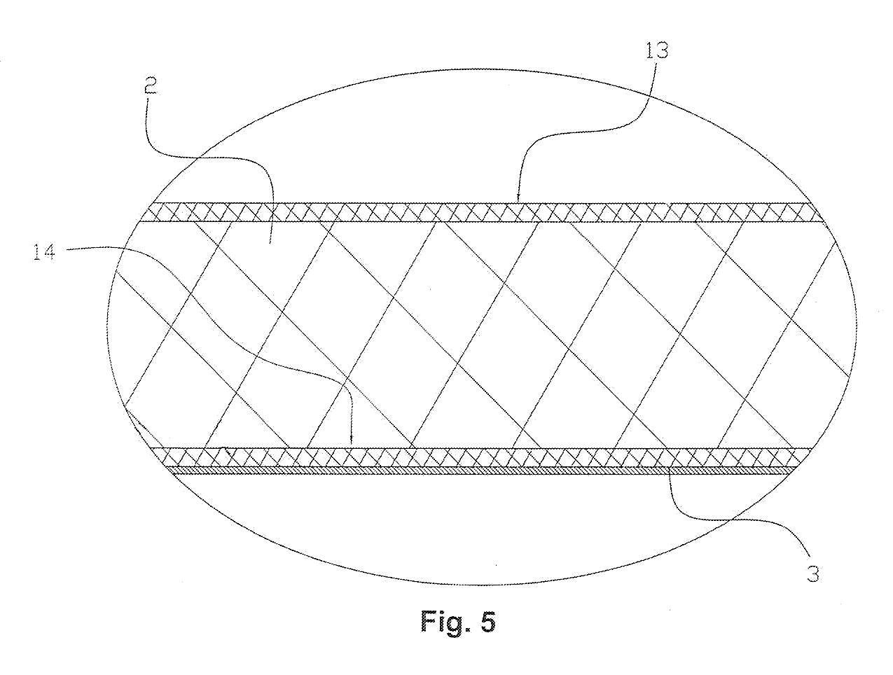

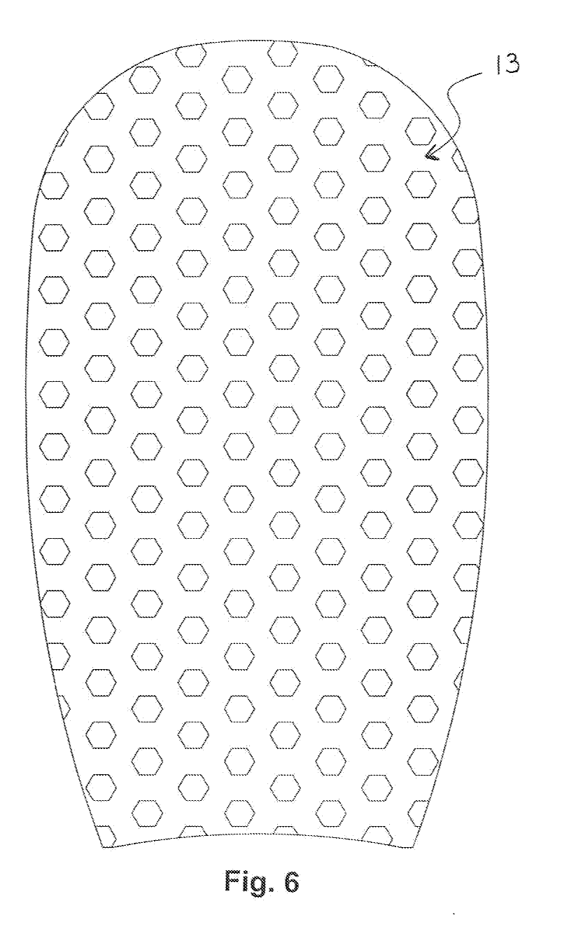

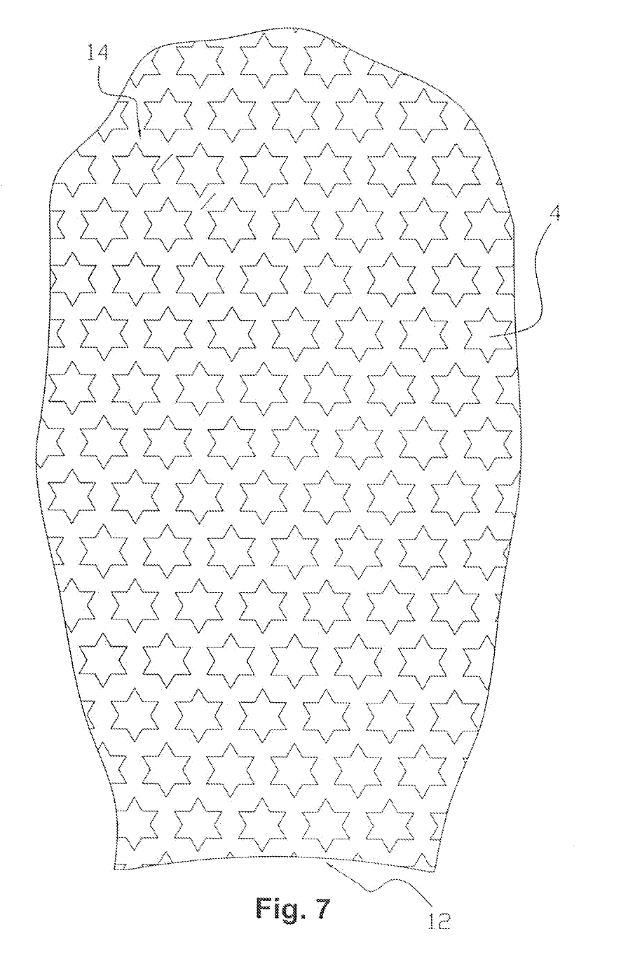

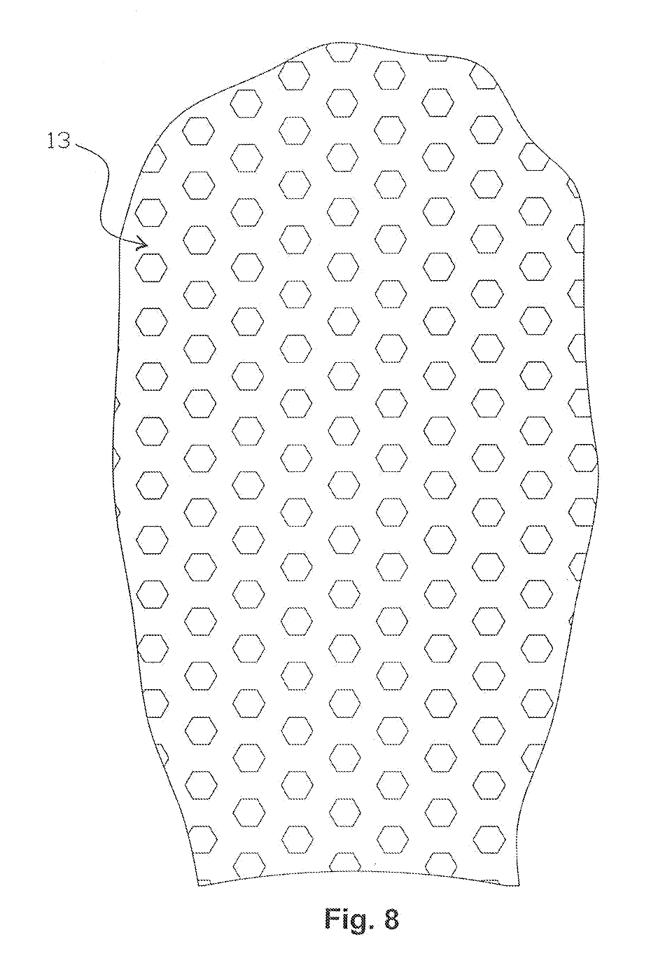

Turning now in detail to FIGS. 1-8, according to one embodiment, a sports board 10 includes a core 2 made of a foam material, such as polystyrene or polypropylene foam, or of a similar material. A cover layer 1 made of a non-woven cloth, or of another suitable material, encases the core 2. In one embodiment, the cover layer 1 is a bag formed by sewing the edges of an upper cloth portion 13 to the edges of a lower cloth portion 14. Patterns or graphics 4 optionally are included on the upper cloth portion 13 or on the lower cloth portion 14.

A slick “skin” or slick layer 3, which may be made of a transparent polyethylene or polypropylene material, or of another suitable material, is laminated on the lower surface of the cover layer 1. A slick layer may optionally be laminated on the upper surface of the cover layer 1, as well.

A method of making the sports board 10, according to one embodiment, includes adding graphics 4 to at least one of the upper cloth portion 13 and the lower cloth portion 14 of the cover layer 1, if such graphics 4 are desired. The graphics 4 may be added to the cloth via the use of ink, such as a sublimation ink, or via any other suitable process. The slick layer 3 is then laminated onto the bottom surface of the lower cloth portion 14. The slick layer 3 is preferably transparent if graphics 4 are included on a bottom surface of the lower cloth portion 14. Alternatively, the slick layer 3 itself may include graphics. An additional slick layer may be laminated onto the top surface of the upper cloth portion 13, if desired, but, for comfort and performance reasons, it is generally preferable to include a cloth upper surface and a slick bottom surface.

The edges of the of upper cloth portion 13 are then sewed to the edges of the lower cloth portion 14, while leaving an opening 12 at one end so that the resultant cover “bag” may be filled with the core material. The edges of the upper and lower cloth portions may be sewed together with their external surfaces facing each other so the cover bag may be turned from inside-out to right-side-out after sewing, which effectively hides the sutures 5 or threads from view. In an alternative embodiment, the upper cloth portion 13 may be sewed to the lower cloth portion 14 before graphics are applied to them. or before the slick layer 3 is laminated onto the bottom surface of the lower cloth portion 14.

A granular foam material, such as granular polystyrene or polypropylene foam material, or another suitable material, is then loaded into the cover bag through the opening 12. The foam granules may each have a diameter of 0.1 to 3 mm, or may be any other suitable size. After the cover bag is filled with the granular core material, the opening 12 in the cover bag is sewed closed to form a sports board pre-structure.

The sports board pre-structure is then placed in a molding apparatus to undergo a molding process. In one embodiment, the molding process involves the application of steam at a temperature of approximately 170 to 180° C. for approximately 2 to 5 minutes. The molded sports board may then be cooled with cooling water or a similar cooling fluid for approximately 2 to 5 minutes, after which the completed sports board 10 is removed from the molding apparatus.

The sports board 10 having a slick layer 3, such as a polyethylene or polypropylene slick layer, is generally stronger and more durable than a conventional board having a cloth upper surface and a nylon lower surface. Thus, the overall performance and life of the sports board 10 is improved. The sports board 10 is also relatively easy to manufacture and to consistently reproduce.

Any of the above-described embodiments may be used alone or in combination with one another. Furthermore, the sports board may include additional features not described herein. While several embodiments have been shown and described, various changes and substitutions may of course be made, without departing from the spirit and scope of the invention. For example, the order of several of the steps described for making the sports board may be changed. For example, the slick layer may be added before or after the upper and lower cloth layers are sewed together. The invention, therefore, should not be limited, except by the following claims and their equivalents.

What is claimed is:

1. A sports board, comprising:
a foam core;
a cover layer encasing the foam core, the cover layer having an upper surface and a lower surface; and
a slick layer laminated on the lower surface of the cover layer.

2. The sports board of claim 1 wherein the slick layer comprises polyethylene or polypropylene.

3. The sports board of claim 1 wherein the foam core comprises polystyrene or polypropylene.

4. The sports board of claim 1 wherein the cover layer comprises an upper cloth layer sewed to a lower cloth layer.

5. The sports board of claim 1 wherein the slick layer is transparent.

6. The sports board of claim 1 wherein the tower surface of the cover layer includes graphics.

7. The sports board of claim 6 wherein the slick layer is transparent such that the graphics are viewable through the slick layer.

8. The sports board of claim 1 wherein the slick layer includes graphics.

9. The sports board of claim 1 wherein the cover layer comprises a non-woven cloth.

10. A method of manufacturing a sports board, comprising the steps of:
providing an upper cloth layer and a lower cloth layer;
laminating a layer of slick material on an outer surface of the lower cloth layer;
sewing edges of the upper cloth layer to edges of the lower cloth layer to form a cover bag including an opening at one end;
filling the cover bag with a granular foam material;
sewing shut the opening in the cover bag to form a sports board pre-form;
placing the pre-form in a molding apparatus;
applying steam to the pre-form for a predetermined amount of time to form the sports board;
cooling the sports board; and
removing the sports board from the molding apparatus.

11. The method of claim 10 wherein the applying step comprises applying steam to the pre-form at a temperature of approximately 170-180° C. for approximately 2 to 5 minutes.

12. The method of claim 10 wherein the cooling step comprises applying water to the sports board for approximately 2 to 5 minutes.

13. The method of claim 10 wherein the slick layer comprises polyethylene or polypropylene.

14. The method of claim 13 wherein the slick layer is transparent.

15. The method of claim 10 wherein the upper cloth layer and the lower cloth layer each comprise non-woven cloth.

16. The method of claim 10 wherein the granular foam material comprises polystyrene or polypropylene.

17. The method of claim 10 further comprising the step of applying graphics to an outer surface of at least one of the upper and lower cloth layers.

18. The method of claim 17 wherein the applying graphics step includes applying graphics to an outer surface of the lower cloth layer, and the laminating step comprises laminating a transparent slick material on the outer surface of the lower cloth layer through which the graphics are visible.

19. The method of claim 10 further comprising the step of turning the cover bag from inside-out to right-side-out before the step of filling the cover bag.

20. A sports board, comprising:
a foam core;
a cloth cover layer encasing the foam core, the cloth cover layer having an upper surface and a lower surface, wherein graphics are included at least on the lower surface; and
a transparent layer of polyethylene or polypropylene laminated on the lower surface through which the graphics are visible.
